(19) United States
(12) Patent Application Publication
(10) Pub. No.: US 2010/0092847 A1
(43) Pub. Date: Apr. 15, 2010

(54) BATTERY COVER LATCHING MECHANISM AND PORTABLE ELECTRONIC DEVICE USING SAME

(75) Inventor: Chang-Zhi LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/566,840

(22) Filed: Sep. 25, 2009

(30) Foreign Application Priority Data
Oct. 13, 2008 (CN) 200810304896.7

(51) Int. Cl. H01M 2/10

(52) U.S. Cl. 429/97

(57) ABSTRACT

A battery cover latching mechanism is provided. The battery cover latching mechanism includes a body member defining a battery receiving space, a battery cover placed above the body member to cover the battery receiving space, and a button assembly. The battery cover including a engaging portion. The button assembly includes a button. The button includes a latching portion. The button is pivotably mounted to the body member to lock the latching portion to the engaging portion or release the latching portion from the engaging portion.

### BACKGROUND

1. Technical Field

The present disclosure relates to battery cover latching mechanisms and, particularly, to a battery cover latching mechanism used in a portable electronic device.

2. Description of Related Art

Batteries are used to provide power to portable electronic devices, e.g., mobile phones. Battery cover latching assemblies are usually provided to secure battery within portable electronic devices.

A typical battery cover latching assembly for an electronic device usually includes a battery cover and latching mechanisms, e.g., a locking pin latching into a locking hole. The battery cover can be detachably mounted to a housing of portable electronic devices using the latching mechanism. However, removal of the battery cover may require a strong force, which may damage the locking pin.

Therefore, there is room for improvement within the art.

### BRIEF DESCRIPTION OF THE DRAWINGS

Many aspects of the battery cover latching mechanism can be better understood with reference to the following drawings. These drawings are not necessarily drawn to scale, the emphasis instead being placed upon clearly illustrating the principles of the present battery cover latching mechanism. Moreover, in the drawings like reference numerals designate corresponding sections throughout the several views.

FIG. 1 is an exploded, isometric view of a battery cover latching mechanism, in accordance with an exemplary embodiment.

FIG. 2 is an isometric view of the button of FIG. 1 from another aspect.

FIG. 3 is an assembled view of the battery cover latching mechanism of FIG. 1.

FIG. 4 is a cross-sectional view of the battery cover latching mechanism shown in FIG. 3 taken along line IV-IV.

FIG. 5 is a schematic view showing a working status of the battery cover latching mechanism shown in FIG. 4.

### DETAILED DESCRIPTION

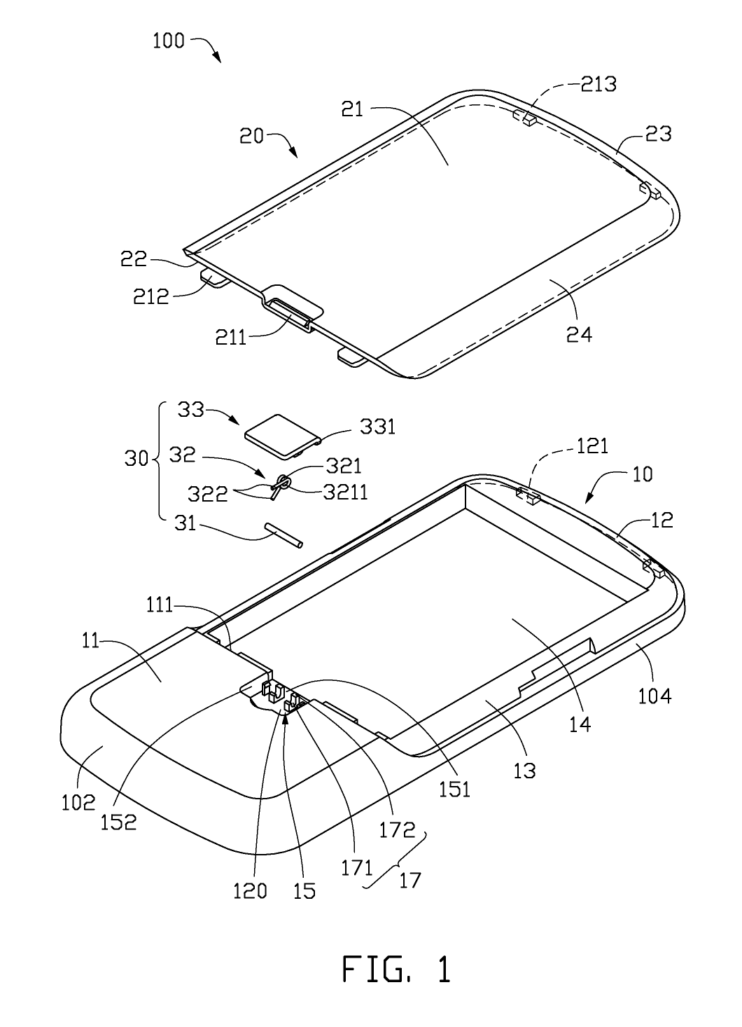

FIG. 1 shows an exemplary battery cover latching mechanism 100 including a body member 10, a removable battery cover 20, and a button assembly 30. The battery cover 20 is attached to the body member 10. The button assembly 30 is pivotably mounted to the body member 10 for releasably locking the battery cover 20 to the body member 10.

The body member 10 can be a housing of a portable electronic device. The body member 10 includes a top portion 11, a bottom portion 12 opposite to the top portion 11, and two opposite sidewalls 13. The two sidewalls 13 connect the top portion 11 and the bottom portion 12 to surround a battery receiving space 14. The top portion 11 defines two first limiting slots 111 and a groove 15 defined between the two limiting slots 111, communicating with the battery receiving space 14. The groove 15 is defined by a bottom wall 151 and three sidewalls 152. The body member 10 further includes two claws 16 and two mounting portion 17 protruding from the bottom wall 151. The two claws 16 are respectively formed at two opposite sidewalls 152. The two mounting portions 17 are also positioned between the two hooks 16. The two claws 16 and the two mounting portions 17 are coaxial for mounting the button assembly 30 therebetween. Each claw 16 includes a hook 161 facing the other claw 16, and can be deformed elastically. Each mounting portion 17 defines a cutout 171 in a middle therefore, and forms two different resisting portions 172. The bottom portion 12 of the body member 10 includes two second limiting slots 121 defined therein.

The removable battery cover 20 is used to cover the battery receiving space 14. The battery cover 20 includes a main plate 21, a first end 22, an opposite second end 23, and two opposite edges 24. The two opposite edges 24 both connect with the first and second ends 22, 23. The main plate 21 includes an engaging portion 211, two first limiting blocks 212 and two second limiting blocks 213. The engaging portion 211 includes a protrusion 2111 and a recess 2112 adjacent to the first end 22. The protrusion 2111 is used to latch the battery cover 20 to the body member 10. The first limiting blocks 212 are secured to on the main plate 21 adjacent to the first end 22, and configured to insert into the first limiting slots 111. The second limiting blocks 213 are formed on the main plate 21 adjacent to the second end 23, and configured to engage into the second limiting slots 121.

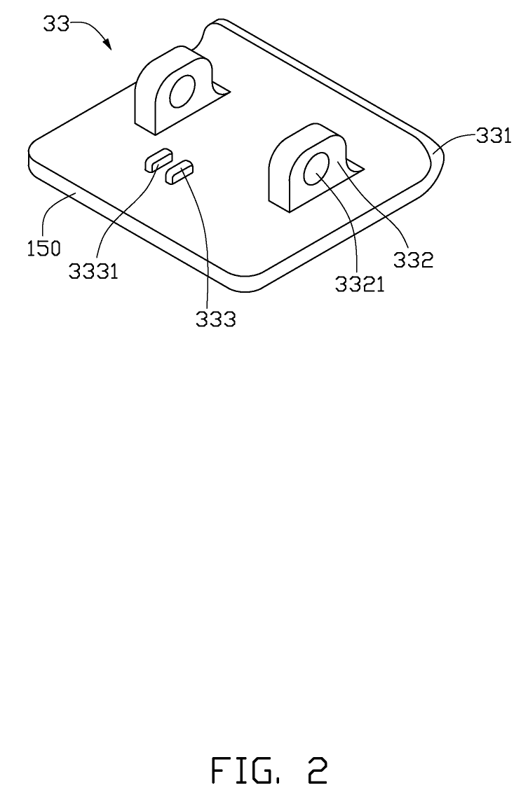

Referring to FIGS. 1 and 2 together, the button assembly 30 includes a shaft 31, an elastic member 32 and a button 33. The shaft 31 is a cylindrical rod. The shaft 31 is inserted into the cutouts 171 of the two mounting portions 17, with both ends of the shaft 31 respectively abutting against one claw 16, thus mounting the shaft 31 to the body member 10. The elastic member 32 is a torsional spring including a main portion 321 and two resisting ends 322 extending from the main portion 321. One resisting end 322 abuts against the bottom wall 151, the other resisting end 322 abuts against the button 33. The main portion 321 is coiled and includes a through hole 3211 therein. The shaft 31 can be received in the through hole 3211, with both ends thereof exposing out of the through hole 3211. The button 33 includes a latching portion 331 formed at one end thereof, two pivoting ledges 332 formed adjacent to the latching portion 331, and two stopping blocks 333 formed at an opposite end. Each pivoting ledge 332 defines a pivoting hole 3321. The two pivoting ledges 332 are opposite to each other, and the two pivoting holes 3321 are co-axial. The shaft 32 is inserted into the two pivoting holes 3321. The two stopping blocks 333 define a stopping space 3331 therebetween. The two stopping blocks 333 are used to limit one resisting end 322 of the elastic member 32 in the stopping space 3331.

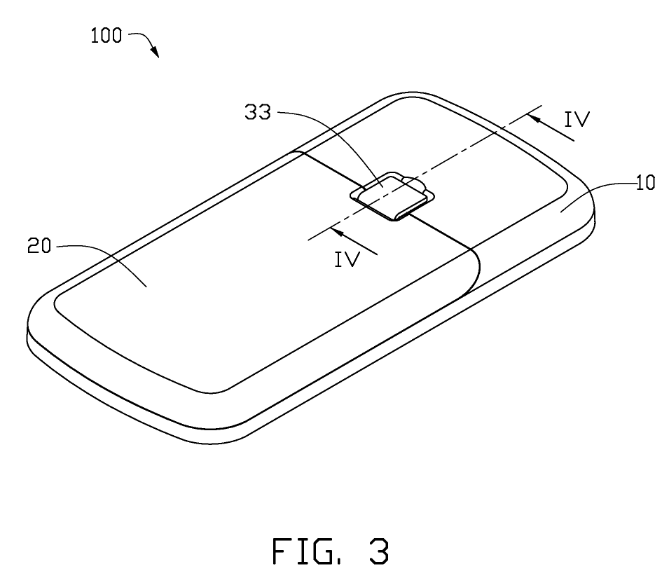

Referring to FIG. 3, to mount the button assembly 30 to the body member 10, the shaft 31 is inserted into one pivoting hole 3321, the through hole 3211 of the elastic member 32 and the other pivoting hole 3321 in order, thus both ends of the shaft 31 are respectively exposed out of one pivoting hole 3321. The button 33 with the shaft 31 and the elastic member 32 is placed over the groove 15, with the shaft 31 aligned with the cutouts 171 and the latching portion 331 adjacent to the battery receiving space 14. The button 33 is pushed into the groove 15 until the shaft 31 is received in the cutouts 171 and both ends of the shaft 31 respectively abut against one claw 16, thus the shaft 31 is stably mounted to the body member 10, and the button 33 can pivot about the shaft 31. At this time, one resisting end 322 abuts against the bottom wall 151 of the groove 15, the other resisting end 322 abuts against an end of the button 33 opposite to the latching portion 331. Thus, an end of the button member 33 with the latching portion 331 is stably supported by the resisting portion 172.

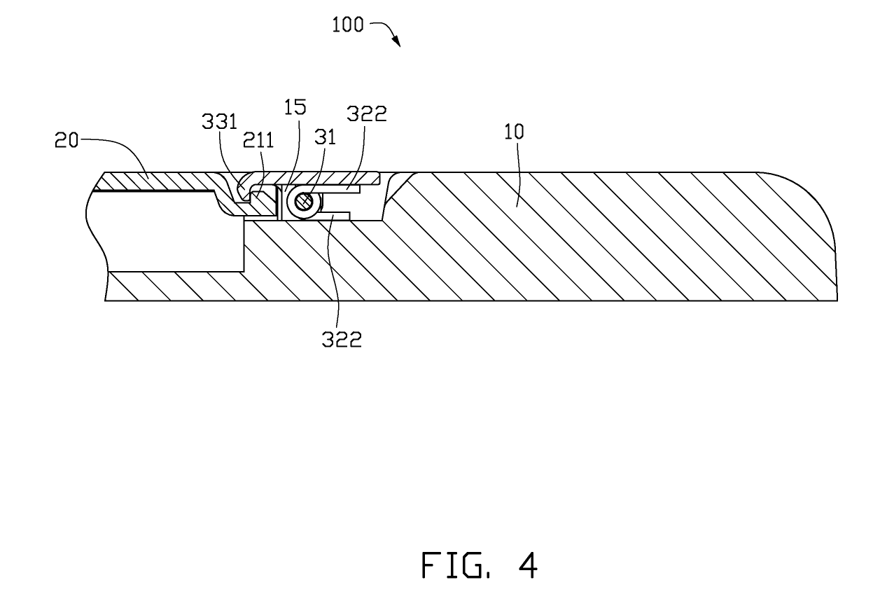

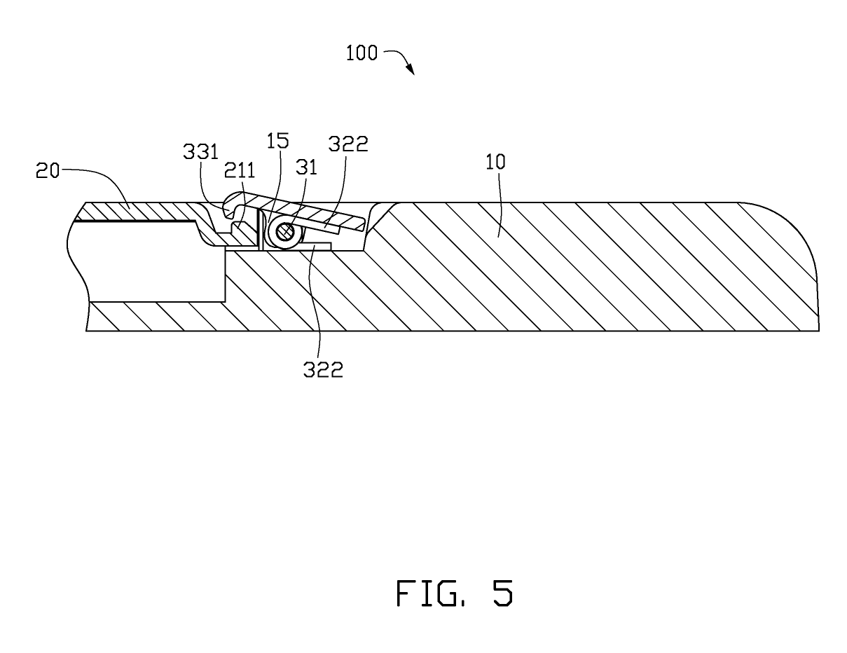

Referring to FIGS. 4 and 5, to mount the battery cover 20 to the body member 10, the battery cover 20 is generally placed over the battery receiving space 14, with the first end 22 facing the top portion 11 of the body member 10. The battery cover 20 is pushed towards the top portion 11 until the engaging portion 211 abuts against the latching portion 331. The battery cover 20 is continuously pushed towards the top portion 11. The engaging portion 211 pushes the latching portion 331 to pivot about the shaft 13 against the elastic member 32 until the engaging portion 211 goes through the latching portion 331. At this time, the latching portion 331 returns to its previous position, thus latching with the engaging portion 211. The first limiting blocks 212 latch into the first limiting slots 111. Then the second end 23 is pressed towards bottom portion 12 until the second limiting blocks 213 latch into the second limiting slots 121. Thus, the battery cover 20 is tightly locked to the body member 10.

To release the battery cover 20 from the body member 10, the end of the button 33 opposite to the latching portion 331 is pressed towards the groove 15 to pivot the button 33 about the shaft 32 until the latching portion 331 is separated from the engaging portion 211. Then the battery cover 20 is pushed towards the bottom wall 12 of the body member 10 until the first limiting blocks 212 are released from the first limiting slots 111, and the second limiting blocks 213 are released from the second limiting slots 121.

The battery cover latching mechanism 100 can tightly lock the battery cover 20 to the body member 10 using the button assembly 30, and also facilitating opening operation of the battery cover 20 without any breakage.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A battery cover latching mechanism, comprising:
a body member defining a battery receiving space,
a battery cover being attached to the body member to cover the battery receiving space, the battery cover including an engaging portion; and
a button assembly including a button, the button including a latching portion, the button being pivotably mounted to the body member to lock the latching portion to the engaging portion or release the latching portion from the engaging portion.

2. The battery cover latching mechanism as claimed in claim 1, wherein the button assembly further includes a shaft fastened to the body member, the button is pivotably mounted to the shaft.

3. The battery cover latching mechanism as claimed in claim 2, wherein the body member defines a groove with a bottom wall and a sidewall, the body member further includes two claws and two mounting portions protruding from the bottom wall of the groove, the two claws are respectively formed adjacent to one sidewall and opposite to each other, the two mounting portions are also formed opposite to each other, the two claws and the two mounting portions are in line, and cooperatively mount the shaft therebetween.

4. The battery cover latching mechanism as claimed in claim 3, wherein each claw includes a hook facing the other claw, each mounting portion includes a cutout extending perpendicular with the sidewalls and a resisting portion adjacent to the cutout, the cutouts receive the shaft therein, the resisting portion resists the button.

5. The battery cover latching mechanism as claimed in claim 1, wherein the button further includes two pivoting ledges adjacent to the latching portion, each pivoting ledge defines a pivoting hole, the shaft are pivotably inserted into the pivoting holes.

6. The battery cover latching mechanism as claimed in claim 3, wherein the button assembly further includes an elastic member formed between the groove and the button, the elastic member compresses the button to pivot about the shaft, with the engaging portion latching to the latching portion.

7. The battery cover latching mechanism as claimed in claim 6, wherein the elastic member is a torsional spring including a main portion and two resisting ends extending from the main portion, one resisting end abuts against the bottom wall, the other resisting end abuts against the button, the main portion is coiled and includes a through hole, the shaft is received in the through hole, with both ends thereof exposing out of the through hole.

8. The battery cover latching mechanism as claimed in claim 7, wherein the button includes two stopping blocks with a stopping space, the two stopping blocks are used to limit one resisting end of the elastic member in the stopping space.

9. The battery cover latching mechanism as claimed in claim 1, wherein the battery cover includes limiting blocks, the body member includes limiting slots, the limiting blocks respectively latch to the limiting slots.

10. A portable electronic device, comprising:
a body member,
a battery cover including a engaging portion, the battery cover being attached to the body member; and
a button assembly including a button and an elastic member, the button including a latching portion, the elastic member being formed between the body member and the button, the button being pivotably mounted to the body member, the elastic member compressing the button to lock the latching portion to the engaging portion.

11. The portable electronic device as claimed in claim 10, wherein the button assembly further includes a shaft fastened to the body member, the button is pivotably mounted to the shaft.

12. The portable electronic device as claimed in claim 11, wherein the body member defines a groove with a bottom wall and a sidewall, the body member further includes two claws and two mounting portions protruding from the bottom wall of the groove, the two claws are respectively formed adjacent to one sidewall and opposite to each other, the two mounting portions are also formed opposite to each other, the two claws and the two mounting portions are in line, and cooperatively mount the shaft therebetween.

13. The portable electronic device as claimed in claim 12, wherein each claw includes a hook facing the other claw, each mounting portion includes a cutout extending perpendicular with the sidewalls and a resisting portion adjacent to the cutout, the cutouts receive the shaft therein, the resisting portion resists the button.

14. The portable electronic device as claimed in claim 11, wherein the button further includes two pivoting ledges adjacent to the latching portion, each pivoting ledge defines a pivoting hole, the shaft are pivotably inserted into the pivoting holes.

15. The portable electronic device as claimed in claim 12, wherein the elastic member is a torsional spring including a main portion and two resisting ends extending from the main portion, one resisting end abuts against the bottom wall, the other resisting end abuts against the button, the main portion is coiled and includes a through hole, the shaft is received in the through hole, with both ends thereof exposing out of the through hole.

16. The portable electronic device as claimed in claim 10, wherein the button includes two stopping blocks with a stopping space, the two stopping blocks are used to limit one resisting end of the elastic member in the stopping space.

17. The portable electronic device as claimed in claim 10, wherein the battery cover includes limiting blocks, the body member includes limiting slots, the limiting blocks latch to the limiting slots.
